(19) United States
(12) Patent Application Publication
(10) Pub. No.: US 2005/0280628 A1
(43) Pub. Date: Dec. 22, 2005

(54) Projector pen image stabilization system

(75) Inventors: Charles R. Adams, Baltimore, MD (US); Harvey C. Nathanson, Pittsburgh, PA (US); Robert S. Howell, Silver Spring, MD (US); Garrett A. Storaska, Reston, VA (US); William E. Hall, New Windsor, MD (US)

Correspondence Address: BIRCH STEWART KOLASCH & BIRCH, PO BOX 747, FALLS CHURCH, VA, 22040-0747, US

(73) Assignee: Northrop Grumman Corp., Baltimore, MD (US)

(21) Appl. No.: 11/126,255

(22) Filed: May 11, 2005

Related U.S. Application Data
(60) Provisional application No. 60/570,099, filed on May 12, 2004.

(51) Int. Cl. G09G 5/00

(52) U.S. Cl. 345/156

(57) ABSTRACT

A high resolution pen-sized projector for controlling the position and size of an image generated by a closed loop control system consists of four major system components including: a virtual VGA display located inside of a XGA display, a position acquisition system, a displacement compensating control system to determine correct position of the VGA display inside of the XGA display, and a dark display area of the background portion of the XGA display.

### PRIORITY DATA

This application claims the priority date of Provisional application No. 60/570,099, filed on May 12, 2004, and is intended to be incorporated herein by reference in its entirety for any and all purposes.

### RELATED APPLICATION

This application is related to U.S. Ser. No. 10/879,041, entitled “Pocket-Pen Ultra-High Resolution MEMS Projection Display In Combination With On-Axis CCD Image Capture System Including Means For Permitting 3-D Imaging”, filed on Jun. 30, 2004. This application is assigned to the assignee of the present invention and is meant to be incorporated herein by reference in its entirety.

### BACKGROUND OF THE INVENTION

1. Field of the Invention

This invention relates generally to a small portable device for projecting a visual image onto an object and more particularly to an image stabilization system for controlling the positioning and size of the image being projected on a surface by a high resolution hand-held pen-sized image projection and acquisition device.

2. Description of Related Art

In the above-referenced related application Ser. No. 10/879,041, there is disclosed a relatively small pocket-size elongated “pocket-pen” device which incorporates a MEMS mirror chip that projects an image on a variety of surfaces and a CCD array type camera that captures the area that the image is projected onto. Three dimensional images can also be projected. The resolution of the projector image is XGA (extended graphics array), which is a high resolution graphics standard (1024×768 pixels) and is normally required for projecting a map or a detailed image; however, such resolution is not required for all applications. For example, applications for projecting surgical instructions onto a patient's body or projecting various shapes and/or text onto a device being repaired comprise two applications where a VGA (video graphics array) standard (720×400 pixels) resolution would normally be sufficient. The primary inherent deficiencies with using a hand-held pen-type projector device such as shown and described in U.S. Ser. No. 10/879,041 in that in both of the above-mentioned applications, as well as with almost all other portable hand-held applications is stability of the image. The present invention is directed to overcoming the stability problem associated with the image projected by a hand-held pen-type image projector.

### SUMMARY

Accordingly, it is an object of the present invention to provide an improvement in image projection by a small portable imaging device;

It is a further object of the invention to provide an improvement in image projection provided by a hand-held pen-sized image projecting device;

And it is yet a further object of the invention to provide image stability of an image projected on a surface by a relatively small hand-held portable device such as a pen-sized projector.

These and other objects are achieved by controlling the position and size of an image generated by a high resolution pen-sized projector by a closed loop control system including four major system components comprising: a virtual VGA display located inside of a XGA display; a position acquisition system; a displacement compensating control system to determine correct position of the VGA display inside of the XGA display; and a dark display area of the background portion of the XGA display.

Further scope of applicability of the present invention will become apparent from the detailed description given hereinafter. However, it should be understood that the detailed description and specific example, while the indicating preferred embodiment of the invention, is given by way of illustration and not limitation, since various changes and modifications within the spirit and scope of the invention will become apparent to those skilled in the art from this detailed description.

### BRIEF DESCRIPTION OF THE DRAWINGS

The following detailed description of the invention will be more fully understood when considered in connection with the accompanying drawings wherein:

FIG. 1 is a diagram illustrative of a virtual VGA display or image located inside of a XGA display or image;

FIG. 2 is illustrative of an object having an image overlayed on to it;

FIG. 3 is an electrical block diagram illustrative of the preferred embodiment of an image stabilization system in accordance with the subject invention located in a small portable projection device;

FIG. 4 is a diagram illustrative of a method for determining the center of a projected image on a background image in accordance with the subject invention; and

FIG. 5 is a flow chart illustrative of the operation of the image stabilization system shown in FIG. 3.

### DETAILED DESCRIPTION OF THE INVENTION

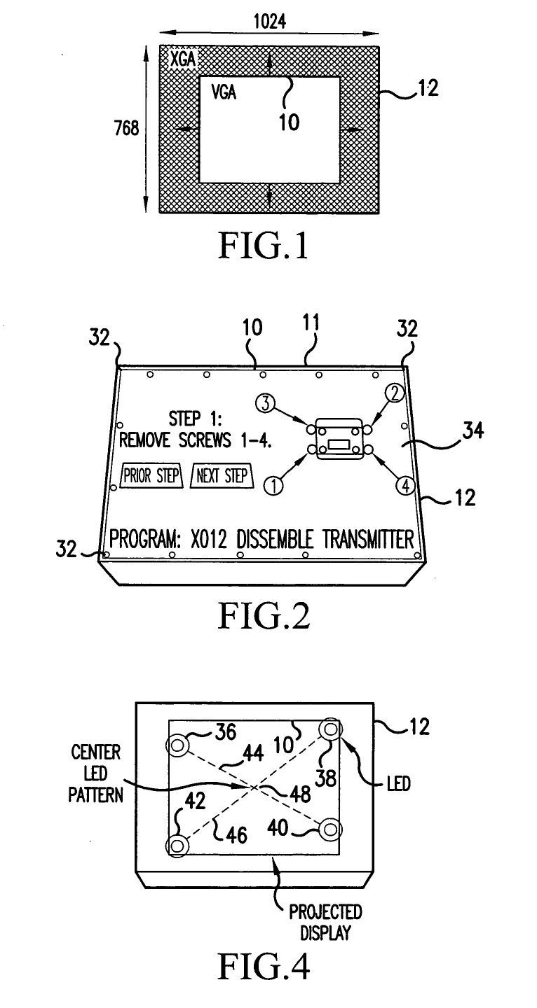

Referring now to the drawings wherein like reference numerals refer to like parts throughout, reference is first made to FIG. 1. Shown there is a virtual display 10 having VGA (video graphics array) standard resolution typically of 640×480 pixels located within an XGA (extended graphics array) display 12 having a resolution of 1024×768 pixels. In the subject invention, the display 10 in one embodiment of the invention is generated in software using a corner tracking method as will be shown hereinafter. The VGA display 10 will move around the XGA display 12 whenever the projector moves. This movement is detected so that the image can be moved back to its original or a new position while the remainder of the XGA display 12 is set to black. In the subject invention, the full XGA resolution of the display 12 will be active but 60% of the pixels will be in the black (off) state at all times, while the VGA image resolution will be used by the remainder of the display. The positioning of the virtual display 10 will be dependent upon the output of the displacement compensating control system shown in FIG. 4, and which will be explained hereinafter.

The VGA display 10 shown in FIG. 1 can also reflect orientation changes such so as in the Z direction (in/out) of the background, i.e., XGA display 12. To the user, this would appear as a change in the size of the projected image 10. This can be accomplished by either changing image resolution or zooming the actual image projected.

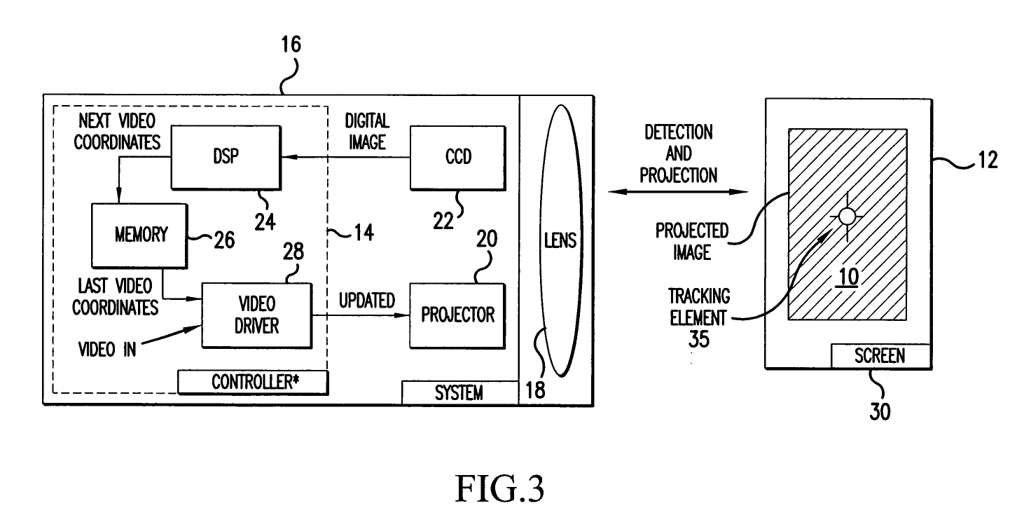

FIG. 2 is illustrative of an example of a displayed image 10 on a board 11 located in a background image 12. The image 10 depicted shows a user, for example, the screws 1, 2, 3 and 4 which must be removed to disassemble the component (transmitter). The system takes a picture of the display area 10 and sends this image to the displacement compensation system 14 as shown, for example, in FIG. 3.

Referring now to FIG. 3, the displacement compensation control system 14 is located in a small portable image projector 16 enclosure 16 which may be, for example, a small pocket-sized elongated “pocket-pen” device as shown in Ser. No. 10/879,041. The projector 16, as shown in FIG. 3, includes in addition to the controller subsystem 14, a lens 18, an image projector unit 20, and a charge coupled device (CCD) camera 22 in the form of an array of CCD elements. Controller 14 is shown including a digital signal processor (DSP) 24, a memory 26, and a video driver 28.

In operation, the projector unit 20 in the hand-held device 16 projects both a VGA display 10 as well as the XGA display 12 on a surface 30, such as a projection screen, nearly flat surface, or a wall, via the projection lens 18. The CCD array 22 detects the projected image of both displays 10 and 12 also by way of the lens 18 and generates a digital image thereof which is coupled to a digital signal processor (DSP) 24. The digital signal processor 24 outputs video coordinate information of the VGA display 10 which is fed to the memory 26 which stores the images. The memory 26 periodically outputs the coordinates of the last image change of the VGA display 10 to the video driver 28, whereupon updated image data is fed to the projector unit 20, which then displays a new image on the screen 30. With respect to the VGA image 10 shown in FIG. 2 and the white margin 32 surrounding the module 34, the software in the digital signal processor 24 will determine the probable boundaries of the module 34. Using this information, the controller 14 will orient the virtual VGA display 10 to the white margin 32. When the hand-held projector 16 is moved, the control system 14 will detect that the edges are not lined up, and will be re-aligned in real time. Thus, the displayed image appears to be stable to the user.

Where the boundaries of the VGA image 10 are not a square shape, such as a human body, certain shapes can still be sensed by the CCD array 22 and the movement of these shapes can be recorded and held in the memory 26 so as to determine where a rectangular VGA image 10 can be moved to make the most sense for the particular application.

Where applications that require Z-axis stability, a similar method is used where the size of the projection is tracked and the zoom of the display is adjusted accordingly.

There are certain applications where daylight or some other type of lighting may not be suitable for the CCD array 22 to pick up any area on which to display. In such a situation, a set of low power infra-red (IR) light emitting diodes (LEDs) is placed in a square-like pattern as shown in FIG. 4 where, for example, four LEDs 36, 38, 40 and 42 are arranged substantially in a rectangle, the digital signal processor 24 would include software which generates two vectors, 44 and 46, emanating from the corners or the vicinity thereof. Where these vectors intersect determines a center point 48 of the LEDs 36, 38, 40 and 42, and in turn the controller 14 will project the image 10 so that the center of the image will correspond to the center 48 of the LED pattern as shown.

The pattern will not always be in disarray. One might imagine an embodiment where a clipboard with four low power IR emitting diodes located at the four corners face the projector 20 and the CCD array 22 so that the rectangularly projected image fills up a rectangle defined by the four IR emitting diodes which are invisible to the naked eye. The IR diodes can also be used in a well lit environment where there is no real clear object that the CCD array will be able to detect the changes.

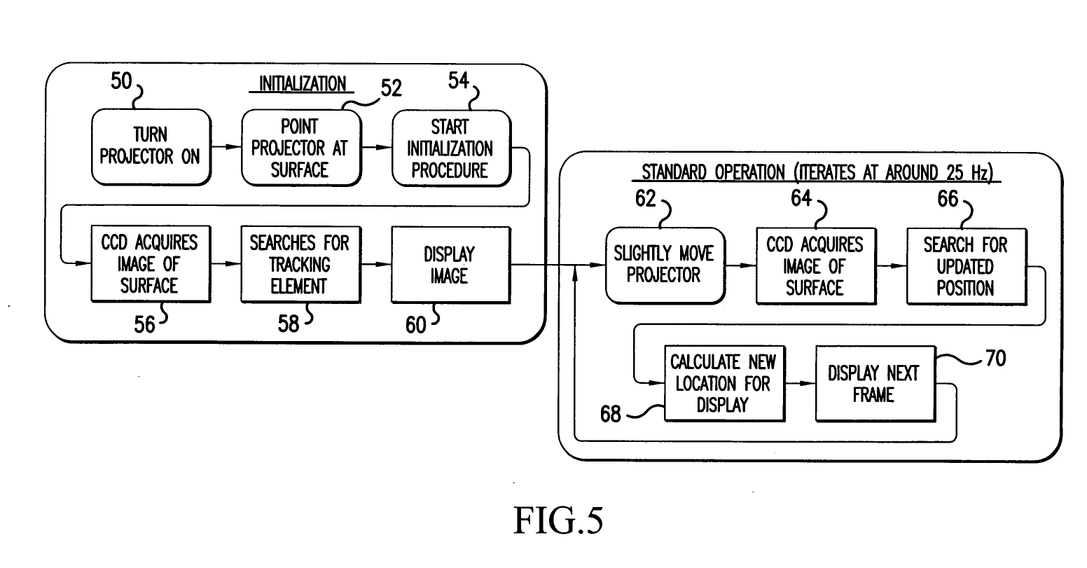

Referring now to FIG. 5, shown thereat is a flow chart which outlines the steps involved in providing stabilization of an image being projected, for example, by the hand-held pen type projection 16 shown in FIG. 3. In FIG. 5, the steps indicated by the rectangular figures are system controlled, while the steps indicated by the rounded edge figures are human interface controlled. The process involves “initialization” followed by “standard operation”. The first step as shown by reference numeral 50 involves turning the projector on, which could also mean turning the image stabilization system ON. Next, the operator points the projection 16 at the surface of the screen in which an image is to be projected, shown by reference numeral 52. An initialization procedure is then started, as shown by reference numeral 54, which could either involve actuation of a button or automatically started during system warm-up. This is followed by step 56 in which the CCD array 22 captures an image 10, for example, for analysis. Next at a step 58, the image is analyzed and dependent upon the application, one or more tracking elements 35, shown in FIG. 3, will be sensed. For night applications, the tracking element will be the infra-red diodes 36 . . . 40 shown, for example, in FIG. 4, while for clip board or standard screen applications, there could be a preset icon, such as a cross hair that tells the system where the image must be centered.

For non-standard projector screen applications such as the human body or a car engine, etc., the tracking element may be the navel on a human body or the car battery under the hood of a car, or any other recognizable arbitrary object. Next, depending upon the particular application, the image will be displayed, shown by step 60, relative to the tracking element. The software in the signal processor 24, for example, will accept these different modes such that, for example, for night applications, this will be displayed in the calculated center 48 of the LEDs 36, 38, 40 and 42 as shown in FIG. 4, and for clip board or other stated screen applications, not shown, the image will be centered around a cross hair, not shown. For other applications such as displayed onto a person, the discriminating tracking element may not be in the center, but will be used as an offset spot on the display.

Standard operation involves a closed loop iterative process which is entered into after initialization. This process will be most effective if each sequence of operation can be performed for every frame of video or every refresh time which is around 24-70 Hz. This refresh rate, however, will be a function of the environmental necessity for stabilization and processing power for the controller system. As shown, stabilization begins with a slight movement of the projector 16 as shown by step 62 which occurs, for example, by the user actually moving the projector 16 causing the stability problem. Next, the CCD array 22 acquires the image appearing on the surface or projector screen, as shown by step 64. This is followed by a search for the position coordinates as shown by step 66. This involves the CCD array 22 using a priori knowledge of where the tracking element 35 was previously and which will then efficiently find the new location of the element so that the image will not have to be entirely scanned.

Next, as shown by reference numeral 68, the signal processor 24 will determine what new location of the display should be and thereafter change and update this value into the memory 26. This is followed by updating the video driver 28 to the location that was calculated in step 68 and display the next frame as shown by stepp 70. This sequence, iteratively repeats itself within about 25 Hz.

Thus what has been shown and described is an image stabilization system for a portable image projector such as a pen-sized projector with a CCD array to project and detect a stable image onto an object by controlling the positioning and the size of the image by a closed loop software positioning package.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An image stabilization system for a portable image projector comprising:
a portable housing;
an image projector located in the housing for generating a visual image which is projected through a lens in the housing onto an external viewing medium, said image comprising a composite image including a first image located within and movable in a second image;
an image acquisition device located in the housing adjacent the lens for sensing the projected image and generating electrical signals corresponding to said first and second images;
a signal processor connected to the image acquisition device for generating a video frame signal of the projected image, said processor being operable to determine the area and boundaries of the first image and compensating for any displacement thereof from an initial position in said second image;
a memory connected to the signal processor for storing the video frame signals of a predetermined number of consecutive video frame signals of the sensed image; and
a video signal generator connected between the memory and the image projector for generating an image signal of the last video frame signal so as to reposition the first image within the second image in the event of any movement of the first image relative to the second image.

2. The system of claim 1 wherein the portable housing comprises a device adapted to be held in the hand of a user.

3. The system of claim 2 wherein the device is in the shape and size of a pocket pen.

4. The system of claim 1 wherein the first image has an image resolution less than the image resolution of the second image.

5. The system of claim 4 wherein the first image has a VGA image resolution and a second image has a XGA image resolution.

6. The system of claim 5 wherein the color of the second image is dark relative to the color of the first image.

7. The system of claim 5 wherein the color of the second image is set so as to be substantially black.

8. The system of claim 4 wherein the image projector includes a MEMS mirror chip for projecting the image on an external surface.

9. The system of claim 4 wherein the image acquisition device includes a charge coupled device (CCD) array for sensing the projected image.

10. The system of claim 4 wherein the projected size of the first image is varied by changing the image resolution or zooming the first image.

11. The system of claim 5 wherein the first image is provided with one or more elements for enabling determination of the boundaries of the first image.

12. The system of claim 11 wherein said one or more elements comprises elements selectively located on the periphery of the first image.

13. The system of claim 11 wherein said one or more elements comprise elements located in the corner regions of the first image.

14. The system of claim 11 wherein said one or more elements comprises light emitting diodes located at selected points of the first image.

15. The system of claim 14 wherein said light emitting diodes comprise infra-red diodes.

16. The system of claim 1 1 wherein said one or more elements comprise a target element selectively located in the first image.

17. The system of claim 16 wherein the target element is located substantially at the center of the first image.

18. A method of stabilizing a projected visual display, comprising the steps of:
sensing the projected visual display and generating electrical signals corresponding to the sensed display;
processing the sensed display by generating a video frame signal of the sensed display, determining the size, area and boundaries of at least one portion of the display and compensating for any displacement of said one portion of the display;
storing the video frame signals of a predetermined number of consecutive video frame signals; and
generating a display signal of the last video frame signal so as to reposition said one portion of the display in the event of any movement thereof.

19. The method of claim 18 wherein said at least one portion of the display comprises a first image located within a second image.

20. The method of claim 19 wherein the first image has an image resolution less than the image resolution of the second image.

21. The method of claim 20 wherein the first image has a VGA resolution and the second image has an XGA image resolution.

22. The method of claim 21 wherein the second image provides a background for the first image and is darker in color than said first image.

23. The method of claim 22 wherein the first image is geometrical in shape and includes one or more elements for determining the boundaries of the first image.

24. The method of claim 23 wherein said elements comprise light emitting elements.

25. The method of claim 24 wherein said light emitting elements comprise light emitting diodes including infra-red diodes.

26. The method of claim 18 wherein the display is generated by a portable hand-held image projector.

27. The method of claim 26 wherein the hand-held image projector is in the shape and size of a pocket pen.
